(19) United States
(12) Patent Application Publication
(10) Pub. No.: US 2005/0270148 A1
(43) Pub. Date: Dec. 8, 2005

(54) Trailer tire monitoring system and method

(76) Inventors: Calvin Modawell, Troy, MI (US); Riad Ghabra, Dearborn Heights, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/862,522

(22) Filed: Jun. 7, 2004

(51) Int. Cl. B60C 23/00

(52) U.S. Cl. 340/445; 340/539.1; 73/146.5

(57) ABSTRACT

A trailer tire monitoring system and method is employed with a trailer having tires and being towed by a vehicle. The trailer tire monitoring system has tire sensor assemblies, each mounted in a respective one of the trailer tires, with each tire sensor assembly including a sensor apparatus that monitors at least one tire operating parameter and a wireless transmitter apparatus capable of wirelessly transmitting data relating to the at least one tire operating parameter. The monitoring system also has a relay unit preferably mounted on the trailer and including a relay receiver adapted for receiving the wirelessly transmitted data from the wireless transmitters of the tire sensor assemblies, and a wireless relay transmitter that wirelessly transmits the data. An in-vehicle receiver receives the wirelessly transmitted data from the wireless relay transmitter, and an in-vehicle indicator is in communication with the in-vehicle receiver and available to the vehicle operator.

### BACKGROUND OF INVENTION

The present invention relates to tire pressure monitoring systems and associated methods.

It is known in the automotive industry to provide for wireless monitoring of the tire pressure for the tires mounted on a vehicle, with a warning or pressure display provided to the vehicle operator. In such monitoring systems, pressure and sometimes other sensors, as well as transmitters and power sources, such as batteries, are mounted inside each tire, typically adjacent to the valve stem. The pressure in each tire is transmitted—typically via radio frequency transmission—to a receiver located in the vehicle. A controller in communication with the receiver processes the information and then may display the tire pressure information, or actuate some type of visual or audible warning device if one of the tires is beyond a certain predetermined threshold, or both. Such systems, then, allow the vehicle operator to assure that the vehicle tires are adequately inflated while traveling down the road.

Often, motor vehicles travel while towing a trailer. In these situations, a vehicle operator may also wish to be assured that the trailer tires are adequately inflated. Some have attempted to address this desire. In one such attempt, transmitters in all of the vehicle tires and trailer tires transmit tire pressure signals directly to a receiver in the vehicle that is connected to the vehicle data bus. For a vehicle towing a trailer, the tire pressure sensor-transmitters in the trailer tires may be very far from the receiver in the vehicle due to the length of the trailer, trailer hitch, and sometimes vehicle bed. Requiring the small transmitters in the trailer tires to send a signal over this distance is not very practical. Consequently, this system is not particularly desirable for trailer tire monitoring. In another attempt, tire pressure sensors are included in the trailer tires, and the tire pressure data is transferred through wires connected from the trailer to the tire pressure warning system on the truck. Such a system, then, requires running extra wires, which are exposed to the harsh environment around the trailer hitch, from the trailer to the truck. Having to wire a trailer and vehicle with these extra wires is not particularly desirable and can create cost and reliability concerns to such a system.

Moreover, both of these systems require the vehicle to be already equipped with components—such as a data bus, controller, and receiver—with an ability to receive, process and display the trailer tire information in addition to the vehicle tire information. Such systems do not provide any flexibility if one desires to have trailer tire monitoring when the trailer is moved to a different vehicle that does not have this equipment built-in.

Thus, it is desirable to have a tire pressure monitor for trailer tires that can be employed by the operator of a vehicle towing a trailer that overcomes the drawbacks of the prior art.

### SUMMARY OF INVENTION

In its embodiments, the present invention contemplates a trailer tire monitoring system for use with a trailer having at least two pneumatic tires and being towed by a vehicle. The trailer tire monitoring system preferably has a first and a second tire sensor assembly, each mounted in a respective one of two of the at least two pneumatic tires, with each tire sensor assembly including a sensor apparatus that monitors at least one tire operating parameter and a wireless transmitter apparatus capable of wirelessly transmitting data relating to the at least one tire operating parameter. A relay unit is preferably mounted on the trailer, but may be mounted on the vehicle in close proximity to the trailer, and includes a relay receiver adapted for receiving the wirelessly transmitted data from the wireless transmitters of the first and second tire sensor assemblies, and a wireless relay transmitter adapted for wirelessly transmitting the data. An in-vehicle receiver is adapted for receiving the wirelessly transmitted data from the wireless relay transmitter, and an in-vehicle indicator is in communication with the in-vehicle receiver.

The present invention also contemplates a method for remote monitoring a parameter of a trailer tire on a trailer being towed by a vehicle, the method comprising the steps of: sensing a tire parameter within the trailer tire with a tire sensor assembly; wirelessly transmitting the tire parameter from the tire sensor assembly to a relay unit mounted on one of the trailer and the vehicle; wirelessly transmitting the tire parameter from the relay unit to a receiver located in the vehicle; and activating an indicator located in the vehicle when the tire parameter reaches a predetermined threshold.

An advantage of an embodiment of the present invention is that the trailer tires on a trailer being towed by a vehicle can be monitored by an operator of the vehicle to assure that a parameter, such as air pressure, is within a certain limit. A warning can be presented to the vehicle operator when a trailer tire reaches a predetermined threshold (such as a low air pressure in the tire), thus allowing the operator to take the appropriate actions.

An additional advantage of an embodiment of the present invention is that the trailer tire parameter sensing and wireless transmitting assemblies can be easily installed on the trailer.

Another advantage of an embodiment of the present invention is that the trailer can be towed by a different vehicle, with the in-vehicle receiver and indicator being easy to move to the different vehicle in order for the operator of the different vehicle to monitor a parameter of the trailer tires. Thus, in this embodiment, the trailer tire monitoring is not limited to vehicles that are pre-equipped with trailer tire system components.

A further advantage of an embodiment of the present invention is that the trailer tire parameter monitoring can be integrated into vehicle systems that already include a receiver and indicator, thus minimizing additional component cost of the in-vehicle portion of the system.

### BRIEF DESCRIPTION OF DRAWINGS

FIG. 1 is a schematic illustration of a trailer tire monitoring system employed with a trailer and towing vehicle, in accordance with an embodiment of the present invention.

FIG. 2 is a schematic illustration, on an enlarged scale, of the portable in-vehicle receiver-indicator unit of FIG. 1.

FIG. 3 is a schematic illustration of a tire monitoring system employed with a trailer and towing vehicle, in accordance with a second embodiment of the present invention.

FIG. 4 is a schematic illustration of a tire monitoring system employed with a trailer and towing vehicle, in accordance with a third embodiment of the present invention.

FIG. 5 is a simplified, representative flow chart illustrating a method of monitoring trailer tires on a trailer from within a vehicle towing the trailer, in accordance with an embodiment of the present invention.

### DETAILED DESCRIPTION

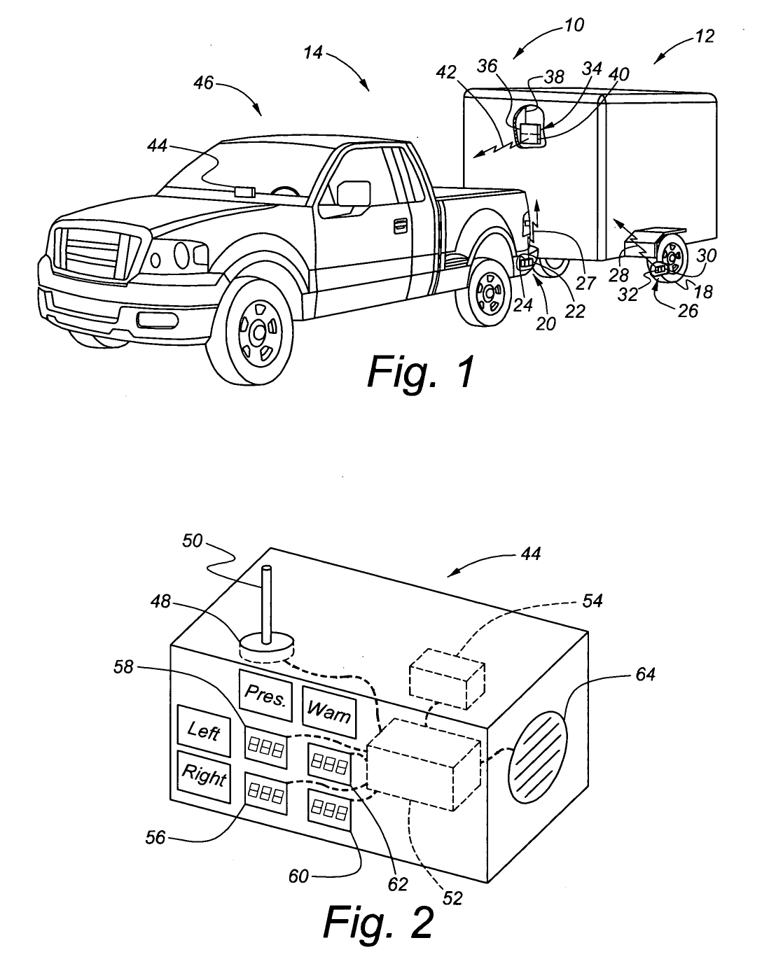

FIGS. 1 and 2 illustrate a trailer tire monitoring system, indicated generally at 10, that is employed with a trailer 12 being towed by a vehicle 14. Of course, while the vehicle 14 is illustrated as a pickup truck and the trailer 12 as a small general utility trailer, the system and method of the present invention can also be employed with other types of vehicles towing other types of trailers. For example, this system and method may be employed by a car towing a boat trailer, a large truck tractor towing a semi-trailer, and other combinations of vehicles towing trailers.

The trailer 12 includes a first pneumatic tire 16, mounted on the right side of the trailer 12, and a second pneumatic tire 18, mounted on the left side of the trailer 12. When using the term tires herein, this includes the tire-wheel assembly, with sensors, transmitters, etc. being mounted in this tire-wheel assembly. Moreover, while only two tires 16, 18 are illustrated herein for simplicity in describing the invention, the trailer 12 may have any number of tires, each with its own trailer tire sensor assembly.

A first trailer tire sensor assembly 20 is mounted in the first trailer tire 16 and includes a sensor 22, a wireless transmitter 24 and a power source, such as a battery (not shown). Preferably, the first trailer tire sensor assembly 20 is mounted inside the trailer tire 16 on a rim adjacent to the tire inflation valve (not shown), although other mounting locations known in the art may be used instead. The sensor 22 may measure pressure, temperature, tire rotation, or some other operating parameter, and may include multiple sensors that measure different parameters. The wireless transmitter 24 preferably transmits a radio frequency (RF) signal, indicated generally at 27, although other wireless forms of transmitting data relating to the measured parameters may be employed instead, if so desired. A second trailer tire sensor assembly 26 is mounted in the second tire 18 and includes a sensor 30, a wireless transmitter 32 and a power source, such as a battery (not shown). Again, the sensor 30 may measure various operating parameters and the wireless transmitter 32 may employ various forms of wireless data transmission, indicated generally at 28. Also, the wireless transmitters 24, 32 may transmit signals representative of the status of the batteries, including low battery status, as well as signals relating to the particular tire location or unique identifier codes that allow the tire monitoring system 10 to disregard signals from nearby vehicles with different codes. Since it is known in the automotive art to provide sensors and wireless transmitters within vehicle tires to measure and transmit data relating thereto, the trailer tire sensor assemblies 20, 26 will not be described in any more detail herein.

A relay unit 34 is preferably mounted to the trailer 12 and includes a receiver 36 for receiving the signals 27, 28 from the wireless transmitters 24; 32. As such, the receiver 36 may include one or more antennae 38 to improve reception of the signals. The relay unit 34 also includes a wireless relay transmitter 40 that is in communication with the receiver 36. The wireless relay transmitter 40 preferably transmits the data via a radio frequency (RF) signal, indicated generally at 42, although other wireless forms of transmitting data relating to the measured parameters may be employed instead, if so desired. The relay unit 34 has a conventional power source (not shown), which can be a battery or wires that tap into a trailer power supply when available. While the relay unit 34 is shown mounted to the trailer 12, it may also be mounted to the vehicle 14, preferably in close proximity to the trailer, if more desirable to do so. That is, if mounted on the vehicle 14, it is preferable to mount it near the rear, close to the trailer 12, in order to minimize the distance from the wireless transmitters 24, 32.

A portable handheld unit 44 is preferably located in the passenger compartment 46 of the vehicle 14, within visual or audible range of the vehicle operator. This unit 44 includes a receiver 48, which may include an antenna 50, a controller 52, which is in communication with the receiver 48, and a source of power, such as a battery 54, for providing electric power to the various components within the unit 44. Alternatively, the source of power may be provided by wires with a standard connector for jacking into a standard power point within the passenger compartment, such as a cigarette lighter socket. The receiver 48 receives the signals 42 from the wireless relay transmitter 40 in the relay unit 34 and communicates them to the controller 52. The controller 52 preferably comprises an appropriately programmed microprocessor for processing the trailer tire parameter data received from the receiver 48 and for generating tire information signals to be sent to indicators.

In this embodiment, the indicators preferably include right and left trailer tire pressure displays 56, 58, right and left trailer tire warning displays 60, 62, and a speaker 64, all of which are in communication with the controller 52. The displays may be light emitting diodes (LEDs), liquid crystal displays (LCDs), or other means of displaying visual information as is known to those skilled in the art. The right and left tire pressure displays 56, 58 show the current sensed pressure in the trailer tires 16, 18, respectively. The right or left tire warning display 60, 62 is lit when the corresponding trailer tire 16, 18 reaches a predetermined pressure threshold. And, the speaker 64 is activated, producing a warning noise, if either the left or right trailer tire 16, 18 reaches its predetermined pressure threshold. Of course, the indicators just discussed are only examples, and any one or combination of these and possibly other indicators may be employed within the portable handheld unit 44, as is desired for the particular type of trailer application. For example, the warning displays 60, 62 may be integrated with the pressure displays 56, 58, or the pressure displays may be temperature displays instead, if so desired.

Moreover, the portable handheld unit 44 may include a device for adjusting the value of the predetermined threshold, if so desired. In any event, the portable handheld unit 44 will convey the desired trailer tire information to the vehicle operator while the vehicle is being operated.

The advantage with this first embodiment of the present invention is that, when the trailer 12 is towed by a different vehicle (not shown), the portable handheld unit 44 can be easily and quickly transferred to this other vehicle. Thus, the operator of this different vehicle has immediate access to the trailer tire monitoring information without any need for the different vehicle to be modified or pre-equipped for handling trailer tire monitoring.

In regard to the frequency or frequencies at which the transmitters 24, 32, 40 transmit their signals, in order to assure that there is no possibility of the trailer tire sensing system 10 interfering with a tire sensing system that may be employed on the vehicle 14 itself, it may be preferable for the transmitter 40 in the relay unit 34 and possibly also the transmitters 24, 32 in the trailer tires 16, 18 to transmit at a frequency or frequencies other than 315 megahertz or 433 megahertz. These two are the common frequencies at which vehicle tire sensing systems transmit data, and so by transmitting at other frequencies, the possibility of interference may be reduced. On the other hand, one may wish to operate at one or both of these frequencies, with the RF signals from the relay transmitter 40 and the tire sensor transmitters 24, 32 including identifiers that will indicate the particular tire location, as is known in the art. Operating at one or both of these frequencies may be particularly useful when employing the systems described below relative to the second and third embodiment of the present invention.

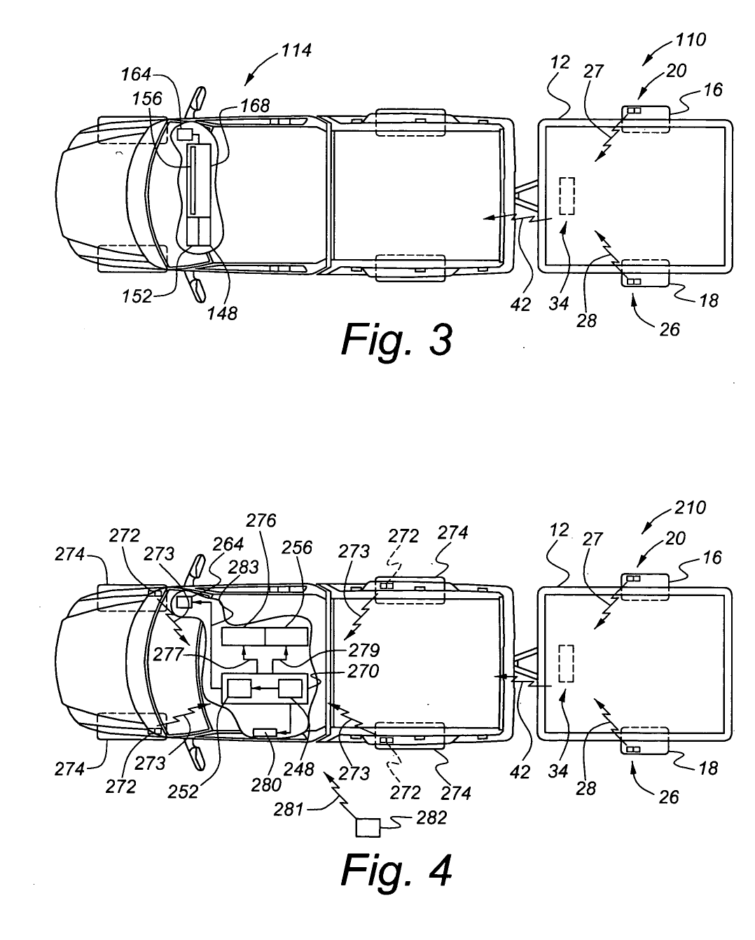

FIG. 3 illustrates a second embodiment of the present invention. The trailer 12 and its components are essentially the same as in the first embodiment. The first trailer tire 16 includes the first trailer tire sensor assembly 20 with a wireless signal 27 broadcast therefrom, and the second trailer tire 18 includes the second trailer tire sensor assembly 26 with a wireless signal 28 broadcast therefrom. The relay unit 34 receives the signals 27, 28 and broadcasts a wireless signal 42.

In this second embodiment, the vehicle 114 includes an audio system 168, preferably mounted in a conventional location in the vehicle instrument panel (not shown). The audio system 168 includes a display 156 and connects to at least one speaker 164. The audio system also includes a receiver 148 that receives the wireless signal 42 transmitted from the relay unit 34 on the trailer. It is preferable to integrate the receiver 148, which receives the wireless signals from the relay unit 34, into the receiver (not shown separately) already employed by the audio system 168 to receive radio broadcast signals in order to reduce the cost. A controller 152 is also included in the audio system 168 and in communication with the receiver 148 and able to produce a display output signal with trailer tire monitoring information. Preferably, the controller 152 is integrated with the audio system controller (not shown separately) that is already employed by the audio system 168 to control the audio system functions and display 156.

In the operation of this second embodiment, the audio system 168 operates in a conventional fashion such that the vehicle operator normally hears and sees the normal audio functions. If so desired, the audio system 168 may include a knob or button that would allow the operator to switch the display to show the trailer tire pressures in the display 156 instead of the audio functions. However, when the monitored parameter of one of the trailer tires 16, 18 reaches the predetermined threshold, the controller 152 briefly interrupts the normal operation of the audio system 168 and activates an audible warning that is broadcast over the audio system speaker 164, or causes a tire warning to be displayed on the display 156, or both. In this way, the vehicle operator is sure to receive the indication that there may be a concern with one of the trailer tires 16, 18.

If the audio system 168 is turned off when the predetermined threshold is reached, then the controller 152 will cause the audio system 168 is to be temporarily activated in order to allow the warning to be conveyed to the vehicle operator. The audio display 156 may show, for example, the particular trailer tire location and the associated temperature or pressure of that trailer tire. Or, the speaker 164 may convey such information in an audible fashion. Preferably, the audio system 168 employs a high definition radio format for ease in adapting and integrating the functions of the trailer tire monitoring system 110 into the audio system 168.

FIG. 4 illustrates a third embodiment of the present invention. The trailer 12 and its components are essentially the same as in the first embodiment. The first trailer tire 16 includes the first trailer tire sensor assembly 20 with a wireless signal 27 broadcast therefrom, and the second trailer tire 18 includes the second trailer tire sensor assembly 26 with a wireless signal 28 broadcast therefrom. The relay unit 34 receives the signals 27, 28 and broadcasts a wireless signal 42. The components of the trailer tire monitoring system 210 that have changed are those located in the vehicle 214.

In this embodiment, the vehicle 214 includes vehicle tire pressure monitoring and/or remote keyless entry systems that are used with the vehicle 214 whether it tows a trailer or not. The vehicle 214 has a control module 270 mounted therein. The control module 270 includes a receiver 248 connected to a controller 252. The receiver 248 is operative to receive the data signals 273 from vehicle tire sensor assemblies 272 mounted in vehicle tires 274, as well as the wireless signal 42 from the relay unit 34. The controller 252 is operative to process these signals from the receiver 248 and to generate an audible alarm signal 283 for one or more speakers 264, a display signal 277 operative to display tire information for the vehicle tires 274 on a display 276, and a signal 279 operative to display tire information for the trailer tires 16, 18 on a trailer tire display 256. The trailer tire display 256 may be separate, as shown, or may be integrated with the display 276, if so desired.

The information shown on the displays 256, 276 may include only a visual warning indicator, or may include actual tire pressure or temperature. The warning indicator may also have an audible alarm with the warning emanating from the speaker 264. The alarm display 256 or speaker 264 are activated if the vehicle tire pressure, trailer tire pressure or another parameter of concern reaches or crosses a predetermined threshold. The particular predetermined threshold chosen depends upon the particular type of vehicle, trailer, tires, etc., that are employed, as is known by those skilled in the art.

Moreover the receiver 248 and controller 252 are preferably further operative to decrypt and process a door lock, unlock, or other signal 281 from the remote keyless entry transmitter 282, and to signal a door lock actuator 280 to activate, as is known to those skilled in the art.

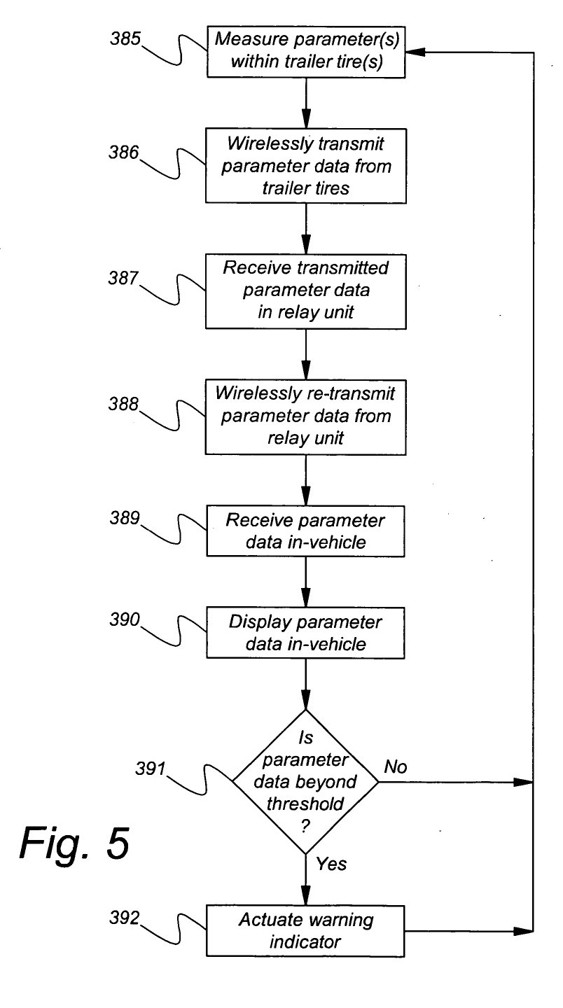

FIG. 5 illustrates a simplified, representative flowchart of the method for remotely monitoring the trailer tires of a trailer being towed by a vehicle. The method includes measuring one or more parameters within the trailer tires, block 385, and wirelessly transmitting the parameter data from the trailer tires, block 386. The relay unit receives the transmitted parameter data, block 387, and re-transmits the parameter data, block 388. The re-transmitted parameter data is received in the vehicle, block 389, and preferably the parameter data is displayed in the vehicle, block 390. The parameter data is compared to a predetermined threshold, block 391, and if it does not reach or go beyond this threshold, then the process repeats. If the parameter data reaches or exceeds the predetermined threshold, then a warning indicator is actuated, block 392.

It should be noted that the simplified flow chart depicted in FIG. 5 is exemplary of the method of the present invention. In that regard, the method may be executed in sequences other than those shown in FIG. 5, including the execution of a subset of the steps shown and the execution of one or more steps simultaneously.

While certain embodiments of the present invention have been described in detail, those familiar with the art to which this invention relates will recognize various alternative designs and embodiments for practicing the invention as defined by the following claims.

1. A trailer tire monitoring system for use with a trailer having at least two pneumatic tires and being towed by a vehicle, the trailer tire monitoring system comprising:
a first and a second tire sensor assembly, each mounted in a respective one of two of the at least two pneumatic tires, with each tire sensor assembly including a sensor apparatus that monitors at least one tire operating parameter and a wireless transmitter apparatus capable of wirelessly transmitting data relating to the at least one tire operating parameter;
a relay unit adapted to mount on one of the trailer and the vehicle and including a relay receiver adapted for receiving the wirelessly transmitted data from the wireless transmitters of the first and second tire sensor assemblies, and a wireless relay transmitter adapted for wirelessly transmitting the data;
a receiver adapted for receiving the wirelessly transmitted data from the wireless relay transmitter and adapted to be located in the vehicle; and
an indicator in communication with the in-vehicle receiver and adapted to be located in the vehicle.

2. The trailer tire monitoring system of claim 1 further including a portable handheld unit that includes the receiver and the indicator and is adapted to be removable from the vehicle.

3. The trailer tire monitoring system of claim 2 wherein the portable handheld unit includes a controller in communication with the receiver and the indicator, and the indicator is at least one visual display mounted on the portable handheld unit.

4. The trailer tire monitoring system of claim 2 wherein the portable handheld unit includes a controller in communication with the receiver and the indicator, and the indicator is at least one speaker mounted on the portable handheld unit.

5. The trailer tire monitoring system of claim 1 wherein the vehicle includes an audio system and the receiver and the indicator are adapted to be integrated with the audio system.

6. The trailer tire monitoring system of claim 1 wherein the vehicle includes a remote keyless entry control module and the receiver and the indicator are adapted to be integrated with the remote keyless entry control module.

7. The trailer tire monitoring system of claim 1 wherein the vehicle includes a vehicle tire pressure monitoring system control module and the receiver and the indicator are adapted to be integrated with the vehicle tire pressure monitoring system.

8. The trailer tire monitoring system of claim 1 further including a controller in communication with the receiver and the indicator, and the indicator is at least one visual display capable of displaying at least one of the at least one tire operating parameter and a trailer tire warning.

9. The trailer tire monitoring system of claim 1 wherein the wireless transmitter apparatus and the wireless relay transmitter are adapted to transmit wireless signals in a radio frequency range.

10. The trailer tire monitoring system of claim 9 wherein the wireless transmitter apparatus and the wireless relay transmitter are adapted to transmit in the radio frequency range at frequencies other than 315 megahertz or 433 megahertz.

11. A trailer tire monitoring system for use with a trailer having at least two pneumatic tires and being towed by a vehicle, the trailer tire monitoring system comprising:
a first and a second tire sensor assembly, each mounted in a respective one of two of the at least two pneumatic tires, with each tire sensor assembly including a sensor apparatus that monitors at least one tire operating parameter and a wireless transmitter apparatus capable of wirelessly transmitting data relating to the at least one tire operating parameter;
a relay unit mounted on the trailer and including a relay receiver adapted for receiving the wirelessly transmitted data from the wireless transmitters of the first and second tire sensor assemblies, and a wireless relay transmitter adapted for wirelessly transmitting the data; and
a portable handheld unit that includes a receiver adapted for receiving the wirelessly transmitted data from the wireless relay transmitter, a controller in communication with the receiver, and an indicator in communication with the controller, and with the portable handheld unit adapted to be removable from the vehicle.

12. The trailer tire monitoring system of claim 11 wherein the indicator is at least one visual display capable of displaying at least one of the at least one tire operating parameter and a trailer tire warning.

13. A method for remote monitoring a parameter of a trailer tire on a trailer being towed by a vehicle, the method comprising the steps of:
sensing a tire parameter within the trailer tire with a tire sensor assembly;
wirelessly transmitting the tire parameter from the tire sensor assembly to a relay unit mounted on one of the trailer and the vehicle;
wirelessly transmitting the tire parameter from the relay unit to a receiver located in the vehicle; and
activating an indicator located in the vehicle when the tire parameter reaches a predetermined threshold.

14. The method of claim 13 further including the step of displaying the tire parameter received by the receiver located in the vehicle.

15. The method of claim 13 wherein the tire parameter is a pressure measured within the trailer tire.

16. The method of claim 13 wherein the receiver located in the vehicle and the indicator located in the vehicle are integrated into a portable handheld unit.

17. The method of claim 13 wherein the step of wirelessly transmitting the tire parameter from the relay unit to the receiver located in the vehicle includes wirelessly transmitting in a radio frequency range.

18. The method of claim 17 wherein the step of wirelessly transmitting in the radio frequency range includes wirelessly transmitting in the radio frequency range at a frequency other than 315 megahertz and 433 megahertz.

19. The method of claim 13 wherein the vehicle includes an audio system and the step of activating an indicator further includes interrupting the audio system operation when the indicator is activated.

20. The method of claim 13 wherein the step of activating an indicator includes at least one of activating a visual display located in the vehicle and activating a speaker in the vehicle to create an audible sound.
